(19) United States
(12) Patent Application Publication
(10) Pub. No.: US 2025/0246742 A1
(43) Pub. Date: Jul. 31, 2025

(54) BATTERY ASSEMBLY

(71) Applicant: Schaeffler Technologies AG & Co. KG, Herzogenaurach (DE)

(72) Inventors: Timothy CHAMBERLAIN, Wooster, OH (US); Victor NORWICH, Wooster, OH (US); Matthew WISE, Hamilton, OH (US)

(21) Appl. No.: 18/422,197

(22) Filed: Jan. 25, 2024

(51) Int. Cl. H01M 50/264; H01M 10/0585; H01M 10/48; H01M 50/211

(52) U.S. Cl. CPC H01M 50/264; H01M 10/0585; H01M 10/482; H01M 50/211

(57) ABSTRACT

A battery assembly includes a first end section and a second end section; a plurality of battery cells stacked between the first end section and the second end section; a transmission system connecting the first end section and the second end section together; and an actuator motor configured for driving the transmission system to vary a distance between the first end section and the second end section to impact a pressure applied by the first end section and the second end section to the plurality of the battery cells.

### TECHNICAL FIELD

The present disclosure relates generally to an assembly of battery cells.

### BACKGROUND

Current projections of solid-state cells require that large amounts of pressure be applied to the cell during operation in order to have efficient conduction of ions within the solid electrolyte.

### SUMMARY

A battery assembly includes a first end section and a second end section; a plurality of battery cells stacked between the first end section and the second end section; a transmission system connecting the first end section and the second end section together; and an actuator motor configured for driving the transmission system to vary a distance between the first end section and the second end section to impact a pressure applied by the first end section and the second end section to the plurality of the battery cells.

In examples, the actuator motor is mounted on the first end section.

In examples, the transmission system includes rods connecting the first end section and the second end section to each other.

In examples, the transmission system further includes gears drivingly connected to threads of the rods.

In examples, the rods are screws, and the actuator motor is configured for rotating the gears to drive the screws to impact a force applied by the first end section and the second end section to the plurality of the battery cells.

In examples, the actuator motor includes a housing and at least one output shaft for rotating about a center axis, and the transmission system includes at least one drive belt drivingly connected to the at least one output shaft of the actuator motor and at least one drive shaft configured for being driven by the at least one drive belt to drive the gears.

In examples, the transmission system includes at least one driving gear non-rotatably connected to each drive shaft.

In examples, the transmission system includes at least one driven gear, and the at least one driving gear is configured for driving the at least one driven gear to rotate the rods.

In examples, the at least one driven gear includes a plurality of driven gears, each of the driven gears being at an end of a respective one of the rods.

In examples, the at least one driving gear includes a plurality of driving gears, each of the driving gears engaging a respective one of the driven gears.

In examples, each of the driven gears is a worm wheel and each of the driving gears is a worm gear, the rods being ball screws driven by the worm wheels.

In examples, the at least one drive shaft is rotatably mounted on the first end section.

In examples, the at least one drive belt includes a first drive belt and a second drive belt, the at least one drive shaft including a first drive shaft and a second drive shaft, and the at least one output shaft of the actuator motor includes a first output shaft and a second output shaft, the first output shaft protruding from the housing in a first direction and drivingly engaging the first drive belt, the first drive belt extending from the first output shaft to the first drive shaft in a third direction traverse to the center axis, the second output shaft protruding from the housing in a second direction opposite of the first direction and drivingly engaging the second drive belt, the second drive belt extending from the second output shaft to the second drive shaft in a fourth direction traverse to the center axis, the fourth direction being opposite of the third direction.

In examples, the rods include a first rod, a second rod, a third rod and a fourth rod, the first drive shaft configured for driving the first rod and the second rod, the second drive shaft configured for driving the third rod and the fourth rod.

In examples, the transmission system includes a first driving gear non-rotatably connected to the first drive shaft, a second driving gear non-rotatably connected to the first drive shaft, a third driving gear non-rotatably connected to the second drive shaft and a fourth driving gear non-rotatably connected to the second drive shaft.

In examples, the transmission system includes a first driven gear, a second driven gear, a third driven gear and a fourth driven gear, the first driving gear configured for driving the first driven gear to rotate the first rod, the second driving gear configured for driving the second driven gear to rotate the second rod, the third driving gear configured for driving the third driven gear to rotate the third rod, the fourth driving gear configured for driving the fourth driven gear to rotate the fourth rod.

In examples, each of the battery cells includes: an anode current collector; an anode material on the anode current collector; a cathode current collector; a cathode material on the cathode current collector; and a solid-state electrolyte sandwiched between the anode material and the cathode material for transporting ions between the anode material and the cathode material.

In examples, battery assembly further includes a controller configured to direct the actuator motor to increase a distance between the first end section and the second end section during charging of the battery cells and to decrease the distance between the first end section and the second end section during discharging of the battery cells.

In examples, battery assembly further includes a pressure sensor for measuring a pressure applied by the actuator motor and transmission system to the battery cells, the controller being configured to control the actuator motor to vary the distance between the first end section and the second end section as a function of the measurements by the pressure sensor.

### BRIEF DESCRIPTION OF THE DRAWINGS

The present disclosure is described below by reference to the following drawings, in which:

FIG. 1 shows a plan view of a first end of a battery assembly according to the present disclosure;

FIG. 2 shows a side view along 2-2 in FIG. 1 illustrating a first side of the battery assembly 10;

FIG. 3 shows a side view along 3-3 in FIG. 1 illustrating a second side of the battery assembly 10, which is 90 degrees offset from the view of FIG. 2;

FIG. 4 schematically shows an internal configuration of the battery cells of the battery assembly.

### DETAILED DESCRIPTION

The present disclosure provides a battery assembly that can create large amounts of pressure on battery cells. This battery assembly is particularly advantageous when applied to battery cells including solid state electrolyte, which can require that large amounts of pressure be applied to the cell during operation in order to have efficient conduction of ions within the solid electrolyte. These pressures can vary depending on cell manufacturer and internal design but can be between 1 MPa to 10 MPa. Furthermore, the size of the battery cells in a direction the cells are stacked may change during charge and discharge. Cells stacked in series have a cumulative growth forcing modules that are 500 mm to expand between 50 and 100 mm. By actively expanding with the cells using pressure measurements, the battery assembly of the present disclosure is able to grow with the cell expansion and provide the necessary compression through that entire expansion using a closed loop feedback. This can be accomplished by actively changing the length of the module using a mechanical transmission system provided by the present disclosure.

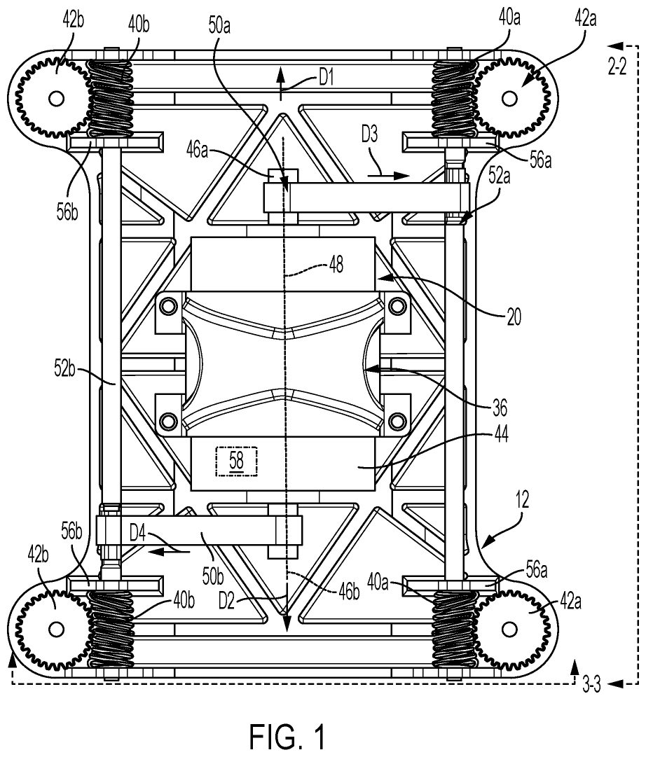

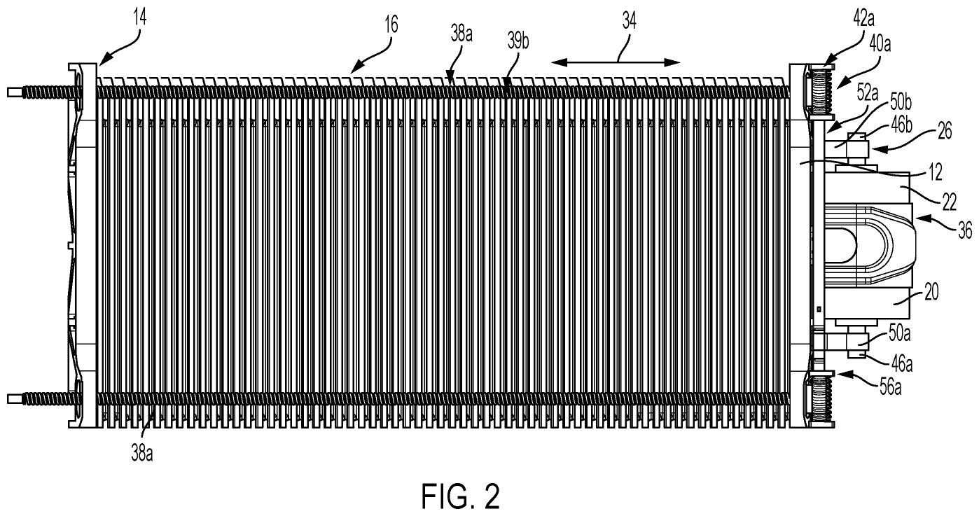

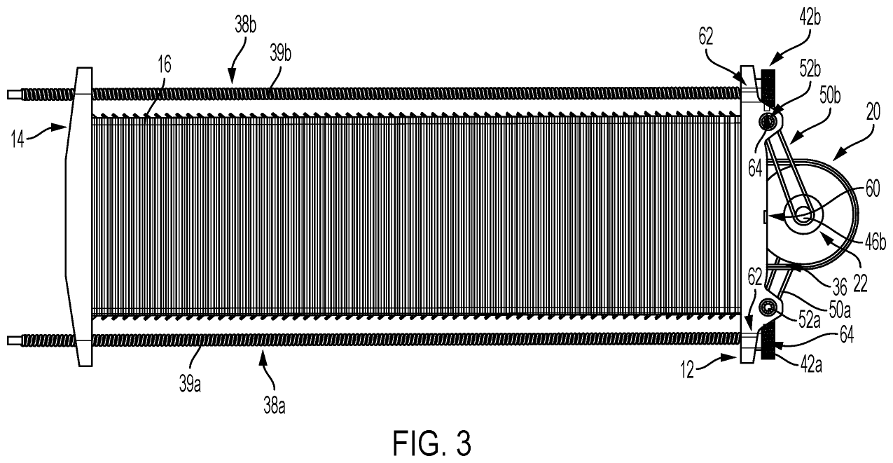

FIGS. 1 to 3 show different views of a battery assembly 10. FIG. 1 shows a plan view of a first end of the battery assembly 10; FIG. 2 shows a side view along 2-2 in FIG. 1 illustrating a first side of the battery assembly 10; and FIG. 3 shows a side view along 2-2 in FIG. 1 illustrating a first side of the battery assembly 10, which is 90 degrees offset from the view of FIG. 2.

The battery assembly 10 includes a first end section 12 and a second end section 14, and a plurality of battery cells 16 stacked between the first end section 12 and the second end section 14. A transmission system 18 connects the first end section 12 and the second end section together 14. An actuator motor 20 is configured to drive the transmission system 18 to vary a distance between the first end section 12 and the second end section 14 to impact a force applied by the first end section 12 and the second end section 14 in a stacking direction 34 to the plurality of the battery cells 16.

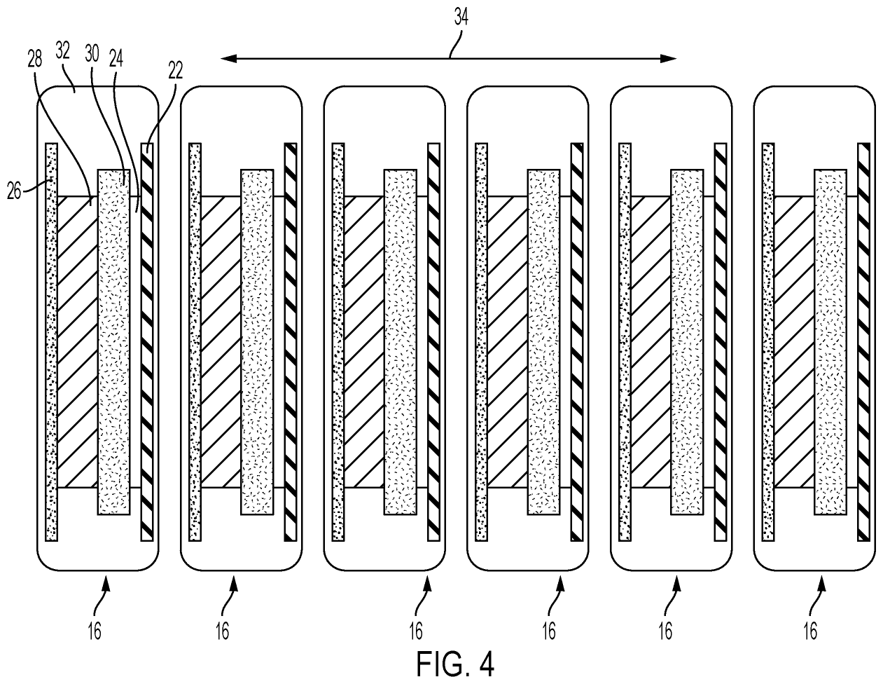

As shown schematically in FIG. 4, each of the battery cells 16 includes an anode current collector 22, an anode material 24 on the anode current collector 22, a cathode current collector 26, a cathode material 28 on the cathode current collector 26 and a solid-state electrolyte 30 sandwiched between the anode material 24 and the cathode material 28 for transporting ions between the anode material 24 and the cathode material 28. In the example shown in FIG. 4, each of battery cells 16 includes packaging 32 surrounding the anode current collector 22, the anode material 24, the cathode current collector 26, the cathode material 28 and the solid-state electrolyte 30. Each packaging 32 can be a pouch formed of aluminum or a polymer. In other examples, each packaging can surround a plurality of battery cells 16. The battery cells 16 can be electrically connected to each other in parallel or in series.

The anode material 24 of each battery cell 16 expands in a stacking direction 34 during charging and contracts in the stacking direction 34 during discharging, which causes each of battery cells 16 to expand in the stacking direction 34 during charging and to contract in the stacking direction 34 during discharging. To prevent issues being caused by expansion and contraction, the battery assembly 10 includes end sections 12, 14, transmission system 18 and motor 20 to provide constant pressure to battery cells 14 during the charging and discharging in order to provide sufficient ionic conductivity between anode material 24 and cathode material 28.

It is noted that cathode material 28 can contract in the stacking direction 34 during charging, but to a lesser extent than anode material 24 expands, and can expand in the stacking direction 34 during discharging, but to a lesser extent than anode material 24 contracts.

Referring back to FIGS. 1 to 3, the actuator motor 20 can be mounted on the first end section 12 by a bracket 36. The transmission system 18 connects two or more rods 38 to the first end section 12 and the second end section 14 and to each other. The rods 38 can be screws, more specifically ball screws. The transmission system 18 also includes gears 40a, 40b, 42a, 42b drivingly connected to the spiral threads 39a, 39b of the rods 38a, 38b.

Torque created by the actuator motor 20 rotates the gears 40a, 40b, 42a, 42b, which drive the rods 38, which in turn adjusts the distance between the first end section 12 and the second end section 14 to maintain a predetermined pressure applied to the plurality of the battery cells 16.

The actuator motor 20 includes a housing 44 and at least one output shaft 46a, 46b extending outside of the housing 44 for rotating about a center axis 48. The transmission system 18 includes at least one drive belt 50a, 50b drivingly connected to the output shaft 30a, 30b of the actuator motor 20 and at least one drive shaft 52a, 52b configured for being driven by the at least one drive belt 50a, 50b, which is wrapped around at least one output shaft 46a, 46b to drive the gears 40a, 40b, 42a, 42b. The gears include at least one driving gear 40a, 40b non-rotatably connected to each drive shaft 52a, 52b, via and at least one driven gear 42a, 42b driven by a respective one of the driving gears 40a, 40b. Driven gears 42a, 42b are configured for rotating the rods 38. Each of the driven gears 42a, 42b are at an end of one of the rods 38 and engages a respective one of the driven gears 40a, 40b.

In the examples shown in FIGS. 1 to 3, the transmission system 18 includes a first drive belt 50a and a second drive belt 50b, a first drive shaft 52a and a second drive shaft 52b, and actuator motor 20 includes a first output shaft 52a and a second output shaft 52b. The first output shaft 52a protrudes from the housing 44 in a first direction D1 and drivingly engages the first drive belt 50a. The second output shaft 52b protrudes from the housing 44 in a second direction D2 opposite of the first direction D1 and drivingly engages the second drive belt 50b. The first drive belt 50a extends from the first output shaft 52a to the first drive shaft 46a in a third direction D3 traverse to the center axis 48. The second drive belt 50b extends from the second output shaft 52b to the second drive shaft 46b in a fourth direction D4 traverse to the center axis, with the fourth direction D4 being opposite of the third direction D3.

The driving gears 40a, 40b can each be a worm gear including spiral teeth and driven gears 42a, 42b can each include a worm wheel including teeth on the outer circumferential surface thereof engaging spiral teeth of the respective driving gear 40a, 42a. The combination of worm gear and worm wheels provides rotational motion without the risk of being back driven, and allows the transmission system 18 to be self-locking. Driven gears 42a, 42b further include helical grooves on the inner circumferential surface thereof receiving balls, allowing each of rods 38a, 38b to be driven by the respective driven gear 42a, 42b via the balls.

The drive shafts 52a, 52b are rotatably mounted on the first end section 12 by flanges 56a, 56b. In the example shown in FIGS. 1 to 3, the transmission system 18 includes four rods 38a, 38b. The first drive shaft 52a is configured for driving two of the rods 38a and the second drive shaft 52b is configured for driving two of the rods 38b. Using a first set of rods 38a that is separate from a second set of rods 38b allow for correct tightening using the same worm gears and worm wheels which would normally cause one side to loosen and the other to tighten. As such, rods 38a have the opposite thread pitch compared to rods 38b.

The transmission system 18 includes two first driving gears 40a non-rotatably connected to the first drive shaft 52a and two second driving gears 40b non-rotatably connected to the second drive shaft 52b. Each of the first driving gears 40a is configured for driving a respective one of the driven gears 42a to rotate a respective one of the rods 38 and each of the first driving gears 40b is configured for driving a respective one of the driven gears 42b to rotate a respective one of the rods 38.

Battery assembly 10 further includes a controller 58 (schematically shown in FIG. 1) configured to control the actuator motor 20 to vary the distance between the first end section 12 and the second end section 14 as a function of whether the battery cells 16 are being charged or discharged, for example based on measurements of a pressure sensor measuring the pressure applied to cells 16 by end sections 12, 14. The controller 58 can be configured to direct the actuator motor 20 to increase a distance between the first end section 12 and the second end section 14 during charging of the battery cells 16 and to decrease the distance between the first end section 12 and the second end section 14 during discharging of the battery cells 16.

As shown schematically in FIG. 3, a sensor in the form of strain gauge 60 can be placed on the first end section 12 to determine the total load and thereby system pressure generated. Torsion springs 62 can be located in the torque path between the at least one of the driven gears 42a, 42b and the rods 38a, 38b to estimate the torque applied to the cells 16 by measuring a deflection of the torsion spring 62 using a respective encoder. To ensure even torque distribution and preload on all of the rods 38a, 38b, battery assembly 10 can further include clutches 64 in the torque paths between driven gears 42a, 42b and the rods 38a, 38b that slip at a preset torque value. The slippage allows all of the rods 38a, 38b to achieve the same preload as the clutches 64 if not initially set to the same preload.

### LIST OF REFERENCE CHARACTERS

10 battery assembly
12 first end section
14 second end section
16 battery cells
18 transmission system
20 actuator motor
22 anode current collector
24 anode material
26 cathode current collector
28 cathode material
30 solid-state electrolyte
30a output shaft
30b output shaft
32 packaging
34 stacking direction
36 bracket
38 rods
38a rods
38b rods
39a spiral threads
39b spiral threads
40a gears
40b gears
42a driven gears
42b driven gears
44 housing
46a at least one output shaft
46b at least one output shaft
48 center axis
50a first drive belt
50b second drive belt
52a first drive shaft
52b second drive shaft
56a flanges
56b flanges
58 controller
60 strain gauge
62 torsion springs
64 clutches

What is claimed is:

1. A battery assembly comprising:
a first end section and a second end section;
a plurality of battery cells stacked between the first end section and the second end section;
a transmission system connecting the first end section and the second end section together; and
an actuator motor configured for driving the transmission system to vary a distance between the first end section and the second end section to impact a pressure applied by the first end section and the second end section to the plurality of battery cells.

2. The battery assembly as recited in claim 1, wherein the actuator motor is mounted on the first end section.

3. The battery assembly as recited in claim 1 wherein the transmission system includes rods connecting the first end section and the second end section to each other.

4. The battery assembly as recited in claim 3 wherein the transmission system further includes gears drivingly connected to threads of the rods.

5. The battery assembly as recited in claim 4 wherein the rods are screws, the actuator motor being configured for rotating the gears to drive the screws to impact a force applied by the first end section and the second end section to the plurality of battery cells.

6. The battery assembly as recited in claim 4, wherein the actuator motor includes a housing and at least one output shaft for rotating about a center axis,
the transmission system includes at least one drive belt drivingly connected to the at least one output shaft of the actuator motor and at least one drive shaft configured for being driven by the at least one drive belt to drive the gears.

7. The battery assembly as recited in claim 6, wherein the transmission system includes at least one driving gear non-rotatably connected to each drive shaft.

8. The battery assembly as recited in claim 7, wherein the transmission system includes at least one driven gear, the at least one driving gear configured for driving the at least one driven gear to rotate the rods.

9. The battery assembly as recited in claim 8, wherein the at least one driven gear includes a plurality of driven gears, each of the driven gears being at an end of a respective one of the rods.

10. The battery assembly as recited in claim 9, wherein the at least one driving gear includes a plurality of driving gears, each of the driving gears engaging a respective one of the driven gears.

11. The battery assembly as recited in claim 10, wherein each of the driven gears is a worm wheel and each of the driving gears is a worm gear, the rods being ball screws driven by the worm wheels.

12. The battery assembly as recited in claim 6, wherein the at least one drive shaft is rotatably mounted on the first end section.

13. The battery assembly as recited in claim 6, wherein the at least one drive belt includes a first drive belt and a second drive belt, the at least one drive shaft including a first drive shaft and a second drive shaft, and the at least one output shaft of the actuator motor includes a first output shaft and a second output shaft,
the first output shaft protruding from the housing in a first direction and drivingly engaging the first drive belt, the first drive belt extending from the first output shaft to the first drive shaft in a third direction traverse to the center axis,
the second output shaft protruding from the housing in a second direction opposite of the first direction and drivingly engaging the second drive belt, the second drive belt extending from the second output shaft to the second drive shaft in a fourth direction traverse to the center axis, the fourth direction being opposite of the third direction.

14. The battery assembly as recited in claim 13, wherein the rods include a first rod, a second rod, a third rod and a fourth rod,
the first drive shaft configured for driving the first rod and the second rod,
the second drive shaft configured for driving the third rod and the fourth rod.

15. The battery assembly as recited in claim 14, wherein the transmission system includes a first driving gear non-rotatably connected to the first drive shaft, a second driving gear non-rotatably connected to the first drive shaft, a third driving gear non-rotatably connected to the second drive shaft and a fourth driving gear non-rotatably connected to the second drive shaft.

16. The battery assembly as recited in claim 15, wherein the transmission system includes a first driven gear, a second driven gear, a third driven gear and a fourth driven gear,
the first driving gear configured for driving the first driven gear to rotate the first rod,
the second driving gear configured for driving the second driven gear to rotate the second rod,
the third driving gear configured for driving the third driven gear to rotate the third rod,
the fourth driving gear configured for driving the fourth driven gear to rotate the fourth rod.

17. The battery assembly as recited in claim 1, wherein each of the battery cells comprises:
an anode current collector;
an anode material on the anode current collector;
a cathode current collector;
a cathode material on the cathode current collector; and
a solid-state electrolyte sandwiched between the anode material and the cathode material for transporting ions between the anode material and the cathode material.

18. The battery assembly as recited in claim 17 further comprising a controller configured to direct the actuator motor to increase a distance between the first end section and the second end section during charging of the battery cells and to decrease the distance between the first end section and the second end section during discharging of the battery cells.

19. The battery assembly as recited in claim 18 further comprising a pressure sensor for measuring a pressure applied by the actuator motor and the transmission system to the battery cells, the controller being configured to control the actuator motor to vary the distance between the first end section and the second end section as a function of measurements by the pressure sensor.
